(19) United States
(12) Patent Application Publication
(10) Pub. No.: US 2024/0271975 A1
(43) Pub. Date: Aug. 15, 2024

(54) THERMAL FLOWMETER AND METHOD FOR OPERATING A THERMAL FLOWMETER

(71) Applicant: Endress+Hauser Flowtec AG, Reinach (CH)

(72) Inventors: Hanno Schultheis, Lörrach (DE); Alexander Grün, Lörrach (DE); Sascha Kamber, Tenniken (CH)

(21) Appl. No.: 18/568,461

(22) PCT Filed: May 18, 2022
(86) PCT No.: PCT/EP2022/063477

§ 371 Date: Dec. 8, 2023

(30) Foreign Application Priority Data
Jun. 16, 2021 (DE) 10 2021 115 553.3

(51) Int. Cl. G01F 1/684; G01F 1/69

(52) U.S. Cl. CPC G01F 1/6842; G01F 1/69

(57) ABSTRACT

A thermal flowmeter includes: a measuring tube; a sensor having a main sensor body and four probes designed to heat the medium, determine the temperature thereof, or influence the flow of the medium in the measuring tube; and an electronic measuring/operating circuit, wherein the probe bodies span a rhombus on the surface of the main sensor body. A first diagonal of the rhombus is parallel to the measuring tube axis, and a second diagonal lies in the measuring tube cross-section. A first probe and a second probe are designed to heat the medium, and at least a third probe is designed to determine the temperature of the medium. The first probe and the second probe are arranged on the first diagonal, and the at least one third probe is arranged on the second diagonal.

This invention relates to a thermal flowmeter and a method for operating a thermal flowmeter.

Thermal flow measurement is based upon drawing conclusions about the mass flow of the medium from the energy input via a probe into a medium flowing past the probe or from the temperature of a heated probe located in the medium. However, the direction in which the medium flows cannot be derived from the energy input or from the temperature of the probe.

Document DE102015118123A1 shows a sensor of a thermal flowmeter which is immersed in a measuring tube of the flowmeter and has several probes which are designed either to heat the medium and measure their own temperature or to measure the temperature of the medium. Furthermore, a flow resistor is designed to produce a direction-dependent incident flow of a heatable probe in order to be able to derive an unambiguous indication of the direction of the flow of the medium in the measuring tube from the directional dependence of the incident flow. However, it has been shown that at low to medium flow rates, a flow direction indication is associated with high uncertainties.

DE102018105046A1 and WO2020244856A1 show further sensors of thermal flowmeters with flow direction detection, in which high uncertainties in the flow direction indication are still present at a low flow rate.

The object of the invention is therefore to propose a flowmeter by means of which reliable detection of the direction of flow of the medium in the measuring tube is made possible.

The object is achieved by a thermal flowmeter according to independent claim 1, and by a method according to independent claim 9.

A flowmeter according to the invention for measuring the mass flow of a medium in a measuring tube comprises:
a measuring tube with a measuring tube wall and a measuring tube axis;
a sensor having four probes which project from a main sensor body into the measuring tube, wherein the probes are designed to heat the medium, determine the temperature thereof, or influence the flow of the medium in the measuring tube;
an electronic measuring/operating circuit which is designed to operate at least three probes and to generate and provide flow measurement values by means of the operation thereof,
wherein each probe has a main probe body and an active probe body, wherein the main probe body is in each case arranged on a side of the corresponding probe facing the main sensor body, and wherein the active probe body is in each case arranged on a side, facing away from the main sensor body, of the corresponding probe,
wherein the active probe body is designed to heat the medium, determine the temperature of the medium, and/or influence the flow of the medium in the measuring tube,
wherein the main probe bodies are columnar,
wherein the main probe bodies span a rhombus on a surface of the main sensor body, wherein the rhombus is defined by surface centroids of cross-sections of the main probe bodies, wherein a first diagonal of the rhombus is parallel to the measuring tube axis, and wherein a second diagonal lies in a measuring tube cross-section,
wherein a first probe and a second probe are designed to heat the medium,
wherein at least a third probe is designed to determine a temperature of the medium,
wherein the first probe and the second probe are arranged on the first diagonal, and wherein the at least one third probe is arranged on the second diagonal.

In this way, power coefficients determined by means of the electronic measuring/operating circuit between a probe designed as a heating element and a third probe can be used advantageously for direction detection, since, in both flow directions, one probe designed as a heating element is directly exposed to the incident flow, and another probe designed as a heating element is arranged in the shadow area of the flow. The fact that the probes designed as heating elements both lie on the first diagonal parallel to the measuring tube axis results in the first probe and the second probe having the same measurement behavior.

In one embodiment, the electronic measuring/operating circuit is designed to use, from a group comprising the first probe and the second probe, a first group member and a third probe to form a pair of probes for measuring the mass flow, and to use the other group member to determine the flow direction,
wherein the electronic measuring/operating circuit is designed, when a change in flow direction is detected, to exchange the group members in order to measure the mass flow and to determine the flow direction.

In one embodiment, the first probe, the second probe, and the at least one third probe each comprise a probe sleeve,
wherein the flowmeter has resistance thermometers, wherein at least one resistance thermometer is arranged in interiors, surrounded by the probe sleeves, of each of the first, second, and third probes, which resistance thermometer is designed to detect a temperature or to emit thermal energy.

In one embodiment, an internal angle β of the rhombus belonging to the first probe is less than 90°, and in particular less than 75° and preferably less than 60°.

In one embodiment, an outer diameter of the probes in respective active regions is at least 1 mm and in particular 1.5 mm and preferably at least 2 mm, and/or at most 7 mm and in particular at most 5 mm and preferably at most 4 mm.

In one embodiment, a centroid of a cross-section of the main probe body of the first probe is at a first distance from a centroid of a cross-section of the main probe body of the second probe, wherein the first distance is at least two outer diameters.

In one embodiment, cross-sections of the probes have a circular outline at least in regions of the active probe bodies.

In a method according to the invention for operating a flowmeter according to the invention, in a first method step, from a group comprising the first probe and the second probe, a first group member with a third probe form a pair of probes for measuring the mass flow, wherein the other group member in each case is used to determine the flow direction, characterized in that, when a change in flow direction is detected in a second method step for measuring the mass flow and for determining the flow direction, the group members are exchanged.

In one embodiment, the electronic measuring/operating circuit determines a first power coefficient using the first probe and at least one third probe, and determines a second power coefficient using the second probe and at least one third probe, wherein the electronic measuring/operating circuit infers a change in flow direction from a progression over time of a difference in the power coefficients—in particular, from a change in sign of the difference.

The invention will now be described with reference to schematic exemplary embodiments.

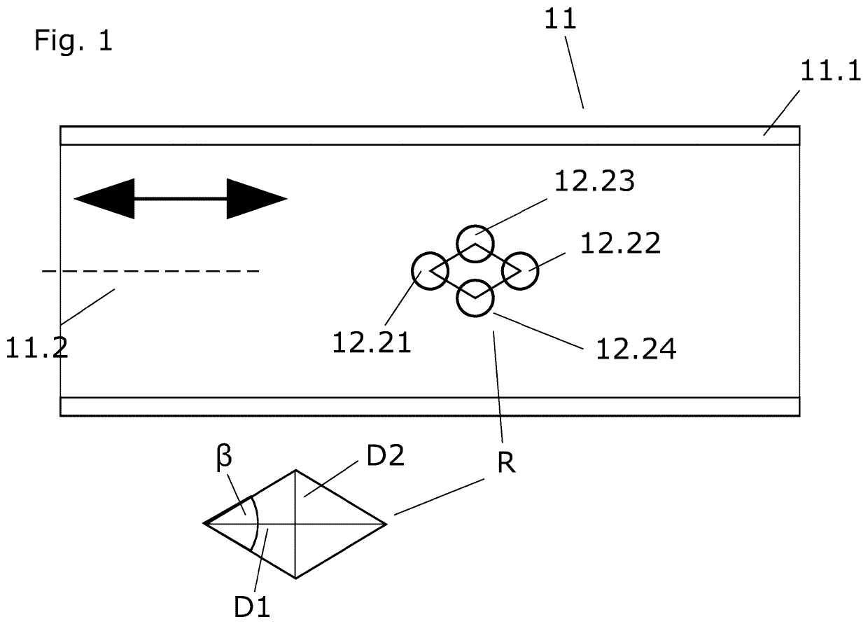

FIG. 1 shows active regions of an exemplary probe arrangement according to the invention of a thermal flowmeter;

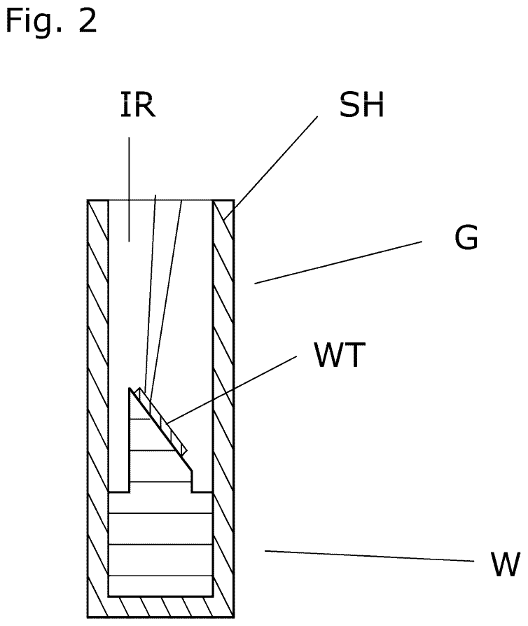

FIG. 2 shows a cross-section through an exemplary first, second, or third probe; and

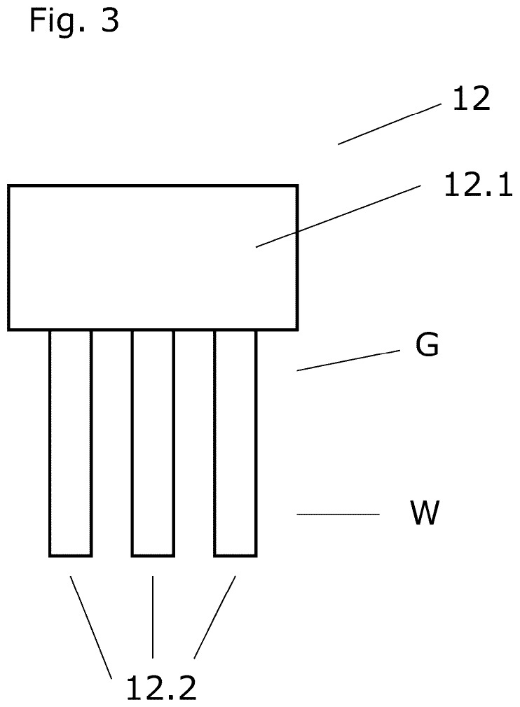

FIG. 3 shows a side view of a sensor according to the invention; and

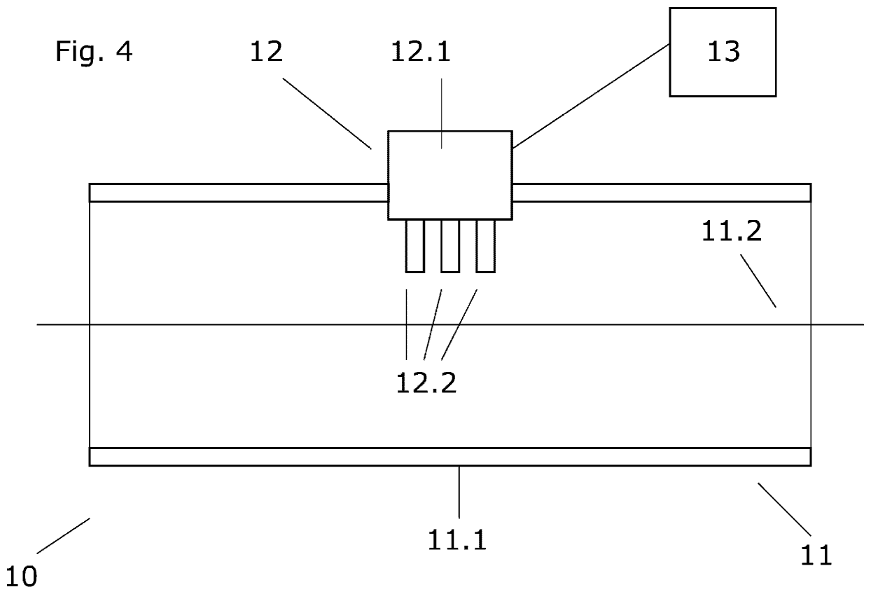

FIG. 4 illustrates a structure of an exemplary schematic thermal flowmeter according to the invention; and

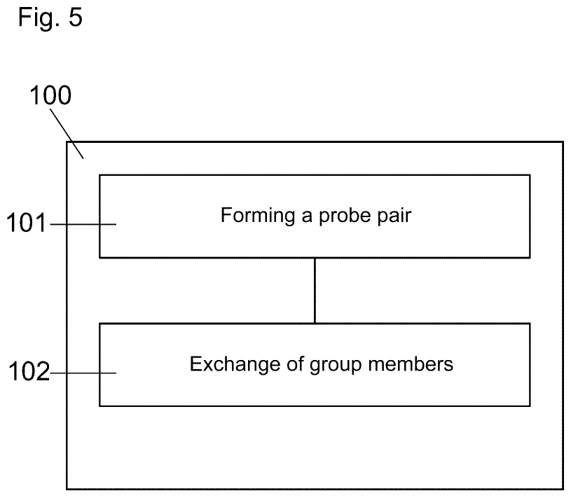

FIG. 5 illustrates the sequence of a method according to the invention.

FIG. 1 shows active regions of a probe arrangement according to the invention in a measuring tube 11 with a measuring tube wall 11.1 with in each case a first probe 12.21, a second probe 12.22, a third probe 12.23, and a fourth probe 12.24. The active regions are the regions in which active probe bodies W (see FIGS. 2 and 3) take effect. The active probe bodies each connect to a main probe body G of the corresponding probe, which main probe bodies are connected to a main sensor body 12.1. The effect of the active probe bodies is to heat the medium, determine the temperature of the medium, and/or influence the flow of the medium in the measuring tube. The first probe 12.21 and a second probe 12.22 are designed to heat the medium, and at least a third probe 12.23 is designed to determine the temperature of the medium. The fourth probe can be solid in this case. Alternatively, instead of the fourth probe, a further third probe can be provided.

The main probe bodies of a probe arrangement span a rhombus, wherein a first diagonal D1 of the diagonal is oriented in parallel to a measuring tube axis 11.2. FIG. 1 illustrates the orientation of the measuring tube axis. A second diagonal D2 lies in a cross-section of the measuring tube.

As a result, a high degree of symmetry or independence of the flow resistor of the sensor from the flow direction of the medium is achieved. An internal angle β associated with the first probe is in this case less than 90 degrees, such that the probe arrangement has a low flow resistance.

According to the invention, the first probe and the second probe are arranged on the first diagonal, and wherein the at least one third probe is arranged on the second diagonal.

In this way, power coefficients determined by means of the electronic measuring/operating circuit (see FIG. 4) between a probe designed as a heating element and a third probe can be used advantageously for direction detection, since, in both flow directions, one probe designed as a heating element is directly exposed to the incident flow, and another probe designed as a heating element is arranged in the shadow area of the flow. Because the probes, which are designed as heating elements, both lie on the first diagonal parallel to the measuring tube axis, the symmetry of the rhombus arrangement results in the first probe having the same measurement behavior, when the flow comes from a first direction, as the second probe when the flow comes from a second direction opposite to the first direction. This arrangement thus proves to be particularly advantageous with regard to measurement accuracy, even given a low flow rate and measurement stability with regard to flow direction detection.

For example, an electronic measuring/operating circuit 13 (see FIG. 4) determines a first power coefficient using the first probe and at least one third probe, and determines a second power coefficient using the second probe and at least one third probe, wherein the electronic measuring/operating circuit infers a change in flow direction from a progression over time of a difference in the power coefficients—in particular, from a change in sign of the difference.

FIG. 2 shows a longitudinal section through an exemplary first, second, or third probe, wherein a probe sleeve SH defines an interior IR of the probe, in which interior the probe has a resistance thermometer WT. The resistance thermometer is thereby thermally and mechanically coupled to the probe sleeve via a contact means. The contact means can, for example, be a molten material melted during production of the probe and subsequently machined after solidification. However, a contacting process such as explosive cladding from the probe sleeve to the contact means and subsequent machining can also be applied, for example. The examples mentioned here are not to be interpreted as limiting.

FIG. 3 shows a schematic side view of a sensor 12 of a thermal flowmeter, which sensor has a main sensor body 12.1 and probes 12.2, wherein the probes, as described in FIGS. 2 a) and b), each comprise a main probe body G and an active probe body W.

FIG. 4 illustrates a schematic structure of a thermal flowmeter 10 according to the invention having a measuring tube 11 with a measuring tube wall 11.1 and a measuring tube axis 11.2, a sensor 12 with a main sensor body 12.1 and with probes 12.2, and an electronic measuring/operating circuit 13 for operating the sensor and providing flow measurement values. The main sensor body is attached in a medium-tight manner in the measuring tube wall. The active regions of the probes are preferably arranged in a flow region of the medium in which a local mass flow deviates by less than 10%, and in particular by less than 5% and preferably by less than 2%, from a mean value formed over a flow cross-section.

FIG. 5 illustrates the sequence of an exemplary method 100 according to the invention.

In a first method step 101, from a group comprising the first probe 12.21 and the second probe 12.22, a group member with a third probe 12.23 form a pair of probes for measuring the mass flow, wherein the other group member in each case is used to determine the flow direction, wherein, when a change in flow direction is detected in a second method step 102 for measuring the mass flow and for determining the flow direction, the group members are exchanged.

In one embodiment, the electronic measuring/operating circuit determines a first power coefficient using the first probe and at least one third probe, and determines a second power coefficient using the second probe and at least one third probe, wherein the electronic measuring/operating circuit infers a change in flow direction from a progression over time of a difference in the power coefficients—in particular, from a change in sign of the difference. In this way, a high degree of independence of a measurement characteristic of the sensor 12 (e.g., FIG. 1) from a flow direction of the medium in the measuring tube can be achieved.

### LIST OF REFERENCE SIGNS

10 Thermal flowmeter
11 Measuring tube
11.1 Measuring tube wall
11.2 Measuring tube axis
12 Sensor
12.1 Main sensor body
12.2 Probe
12.21 First probe
12.22 Second probe
12.23 Third probe
12.24 Fourth probe
13 Electronic measuring/operating circuit
G Main probe body
W Active probe body
SH Probe sleeve
R Rhombus
D1 First diagonal
D2 Second diagonal
WT Resistance thermometer
IR Interior
p Internal angle

1-10. (canceled)

11. A thermal flowmeter for measuring a mass flow of a medium in a measuring tube, the flowmeter comprising:
a measuring tube defined by a measuring tube wall and having a measuring tube axis;
a sensor including four probes which project from a main sensor body into the measuring tube, wherein the probes are configured to heat the medium, determine the temperature of the medium, or influence the flow of the medium in the measuring tube; and
an electronic measuring/operating circuit configured to operate at least three of the four probes and to generate and provide flow measurement values by operation the at least three probes,
wherein each probe includes a main probe body and an active probe body, wherein the main probe body comprises a proximal side adjacent the main sensor body, and wherein the active probe body comprises a distal side facing away from the main sensor body,
wherein each active probe body is operable to heat the medium, determine the temperature of the medium, and/or influence the flow of the medium in the measuring tube,
wherein each main probe body is columnar,
wherein each main probe body spans a rhombus on a surface of the main sensor body, wherein the rhombus is defined by surface centroids of cross-sections of the four main probe bodies,
wherein a first diagonal of the rhombus is parallel to the measuring tube axis, and wherein a second diagonal lies in a measuring tube cross-section,
wherein a first probe and a second probe of the four probes are configured to heat the medium,
wherein at least one third probe of the four probes is configured to determine a temperature of the medium, and
wherein the first probe and the second probe are arranged on the first diagonal, and wherein the at least one third probe is arranged on the second diagonal.

12. The flowmeter according to claim 11,
wherein the electronic measuring/operating circuit is configured to use, from a group comprising the first probe and the second probe, a first member of the group and the at least one third probe to form a pair of probes adapted to measure the mass flow and to use another member of the group in each case to determine a flow direction of the medium in the measuring tube,
wherein the electronic measuring/operating circuit is further configured to exchange the first member and the other member of the group to measure the mass flow and to determine the flow direction when a change in the flow direction is detected.

13. The flowmeter according to claim 11,
wherein the first probe, the second probe, and the at least one third probe each comprise a probe sleeve,
wherein the flowmeter includes resistance thermometers, wherein at least one resistance thermometer is arranged in an interior of each of the first probe, second probe, and at least one third probe, the respective interior surrounded by the corresponding probe sleeve, which resistance thermometer is configured to detect a temperature or to emit thermal energy.

14. The flowmeter according to claim 11, wherein a fourth probe of the four probes is solid.

15. The flowmeter according to claim 11, wherein an internal angle of the rhombus adjacent the first probe is less than 90°.

16. The flowmeter according to claim 15, wherein the internal angle less than 60°.

17. The flowmeter according to claim 11, wherein an outer diameter of each of the four probes in respective active regions is at least 1 mm and/or at most 7 mm.

18. The flowmeter according to claim 17, wherein each respective outer diameter in the respective active regions is at least 2 mm and/or at most 4 mm.

19. The flowmeter according to claim 11,
wherein the centroid of the cross-section of the main probe body of the first probe is at a first distance from the centroid of the cross-section of the main probe body of the second probe,
wherein the first distance is equal to at least two outer diameters.

20. The flowmeter according to claim 11, wherein cross-sections of each of the four probes have a circular perimeter, at least in regions of the active probe bodies.

21. A method for operating the flowmeter according to claim 11, the method comprising:
forming a pair of probes adapted to measure the mass flow, the pair consisting of a first member of a group and the at least one third probe, the group comprising the first probe and the second probe;
determining a flow direction of the medium in the measuring tube using another member of the group in each case; and
when a change in the flow direction is detected while determining the flow direction, exchanging the first member and the other member of the group to measure the mass flow and to determine the flow direction of the medium in the measuring tube.

22. The method according to claim 21, further comprising:
determining a first power coefficient using the first probe and the at least one third probe and determining a second power coefficient using the second probe and the at least one third probe, each determining using the electronic measuring/operating circuit; and
inferring the change in the flow direction from a progression over time of a difference in the first and second power coefficients using the electronic measuring/operating circuit.

23. The method according to claim 22, wherein the progression includes a change in sign of the difference.
